(19) United States
(12) Patent Application Publication
(10) Pub. No.: US 2007/0285882 A1
(43) Pub. Date: Dec. 13, 2007

(54) Computer housing

(76) Inventor: Kuan-Chung Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/450,330

(22) Filed: Jun. 12, 2006

(51) Int. Cl. G06F 1/16

(52) U.S. Cl. 361/683

(57) ABSTRACT

A computer housing includes a first shell, and a second shell connected to the first shell by a pivot mechanism. The pivot mechanism includes two co-axial bushings mounted on the first shell respectively, and two pivot shafts mounted on the second shell respectively and each pivotally mounted in the respective bushing. Thus, the pivot shafts are inserted into the bushings simultaneously in the same direction to connect the first shell and the second shell, so that the second shell is connected to the first shell easily and quickly. In addition, the second shell is a component of the computer housing, so that it is unnecessary to manufacture a rotation case additionally, thereby decreasing the costs of fabrication.

### BACKGROUND OF THE INVENTION

1. Field of the Invention

The present invention relates to a computer housing, and more particularly to a computer housing that is expandable.

2. Description of the Related Art

A conventional computer housing comprises a shell, and a main board mounted in the shell for mounting a peripheral device (hard disk, floppy disk, optical disk and the like) or a power supply. However, the peripheral device or the power supply is mounted on the top of the main board, so that the main board is not assembled easily.

Another conventional computer housing comprises a shell, and a rotation case removably mounted in the shell for mounting the peripheral device or the power supply to save the space. However, it is necessary to manufacture the rotation case additionally, thereby greatly increasing the costs of fabrication. In addition, it is necessary to provide a pivot mechanism and a positioning mechanism so that the rotation case is rotatably connected to the shell stably. Thus, such a computer housing has a complicated construction, thereby greatly causing inconvenience to the user in assembly of the computer housing.

The closest prior art of which the applicant is aware is disclosed in the U.S. Pat. No. 6,330,161 and the Taiwanese Patent Application Nos. 091221548 and 089221833.

### SUMMARY OF THE INVENTION

The present invention is to mitigate and/or obviate the disadvantage of the conventional computer housing.

The primary objective of the present invention is to provide a computer housing, wherein the pivot shafts are inserted into the bushings simultaneously in the same direction to connect the first shell and the second shell, so that the second shell is connected to the first shell easily and quickly.

Another objective of the present invention is to provide a computer housing, wherein the second shell is a component of the computer housing, so that it is unnecessary to manufacture a rotation case additionally, thereby decreasing the costs of fabrication.

A further objective of the present invention is to provide a computer housing, wherein when the second shell is disposed at the second position where the second shell is spaced from the first shell, the mounting space is defined between the first shell and the second shell to facilitate maintenance or assembly of the main board or other parts by the user.

In accordance with the present invention, there is provided a computer housing, comprising:

a first shell having a first side plate having an end formed with an opening and a second side plate located opposite to the first side plate;

a pivot mechanism;

a second shell connected to the first shell by the pivot mechanism, so that the second shell is rotatable between a first position and a second position;

the second shell having a front plate and a rear plate;

wherein, when the second shell is disposed at the second position, a mounting space is defined between the first shell and the second shell, and when the second shell is disposed at the first position, the mounting space is occupied by the second shell, while the front plate of the second shell is flush with the opening of the first shell;

wherein, the pivot mechanism includes two co-axial bushings mounted on two ends of a side of the first shell respectively, and two pivot shafts mounted on two ends of a side of the second shell respectively and each pivotally mounted in the respective bushing.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a computer housing in accordance with the preferred embodiment of the present invention;

FIG. 2 is an exploded perspective view of the computer housing as shown in FIG. 1;

FIG. 2A is a locally enlarged view of a pivot shaft of the computer housing as shown in FIG. 2;

FIG. 3 is a schematic operational view of the computer housing as shown in FIG. 1 in use; and

FIG. 4 is a partially plan cross-sectional assembly view of the computer housing as shown in FIG. 2.

### DETAILED DESCRIPTION OF THE INVENTION

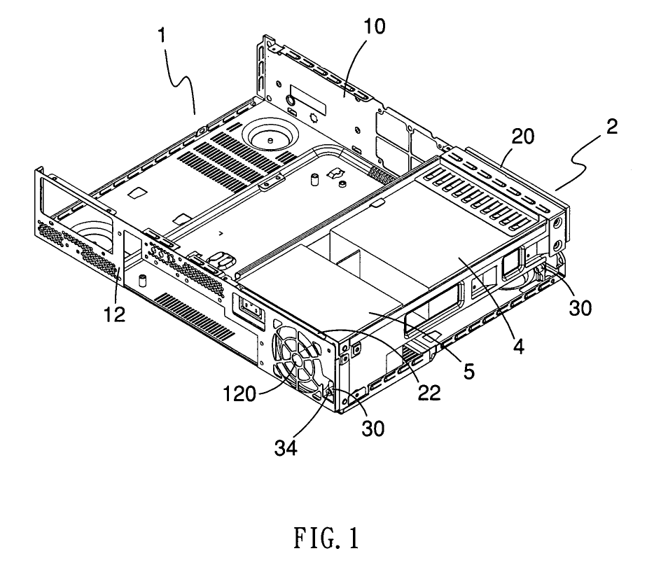

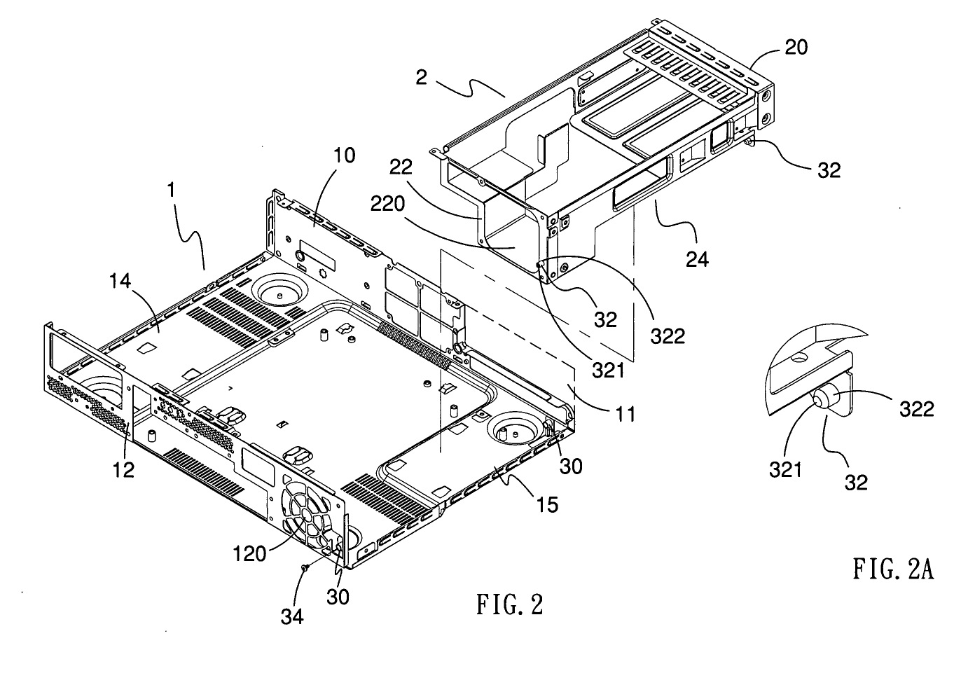

Referring to the drawings and initially to FIGS. 1-3, a computer housing in accordance with the preferred embodiment of the present invention comprises a first shell 1, a second shell 2, and a pivot mechanism.

The first shell 1 has a first side plate 10, a second side plate 12 located opposite to the first side plate 10 and a bottom plate 14 for mounting a main board (not shown). The first side plate 10 has an end formed with an opening 11.

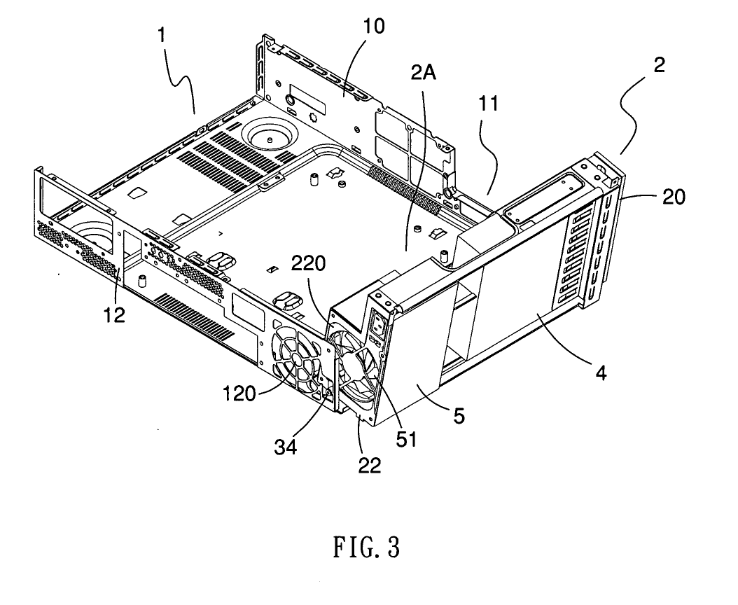

The second shell 2 has a front plate 20 and a rear plate 22. The second shell 2 is connected to the first shell 1 by the pivot mechanism, so that the second shell 2 is rotatable between a first position as shown in FIG. 1 and a second position as shown in FIG. 3.

Thus, when the second shell 2 is disposed at the second position as shown in FIG. 3, a mounting space 2A is defined between the first shell 1 and the second shell 2, and when the second shell 2 is disposed at the first position as shown in FIG. 1, the mounting space 2A is occupied by the second shell 2, while the front plate 20 of the second shell 2 is flush with the opening 11 of the first shell 1.

It is appreciated that, the first shell 1 and the second shell 2 are assembled to form the whole body of the computer housing. Thus, the second shell 2 is not additionally attached to the whole body of the computer housing, just like the conventional rotation case. In addition, when the second shell 2 is disposed at the second position as shown in FIG. 3, the mounting space 2A defined between the first shell 1 and the second shell 2 facilitates maintenance or assembly of the main board or other parts by the user.

Referring to FIGS. 1-4, the pivot mechanism includes two co-axial bushings 30 mounted on two ends of a side 15 of the first shell 1 respectively, and two pivot shafts 32 mounted on two ends of a side 24 of the second shell 2 respectively and each pivotally mounted in the respective bushing 30. Each of the pivot shafts 32 has a fixed end 322 and a free end 321. The free ends 321 of the pivot shafts 32 are directed toward the same direction, so that the pivot shafts 32 are inserted into the bushings 30 simultaneously in the same direction to connect the first shell 1 and the second shell 2. Thus, the second shell 2 is connected to the first shell 1 easily and quickly. Preferably, the bushings 30 are integrally formed on the first shell 1, and the pivot shafts 32 are integrally formed on the second shell 2.

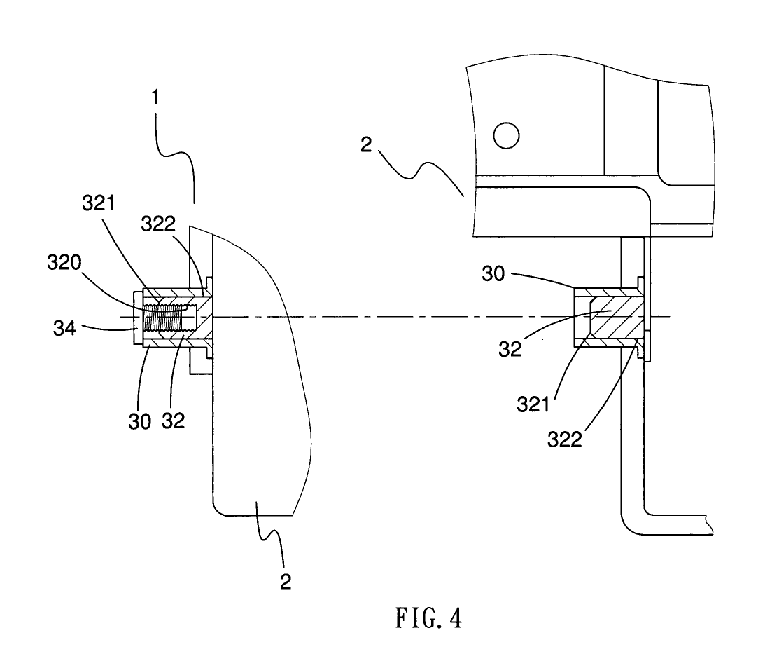

In the preferred embodiment of the present invention, one of the pivot shafts 32 has an inside formed with a screw bore 320 (see FIG. 4), and a screw 34 is screwed into the screw bore 320 of the respective pivot shaft 32 and rested on the respective bushing 30 to lock the respective pivot shaft 32 onto the respective bushing 30.

The second side plate 12 of the first shell 1 has an air outlet 120, the second shell 2 has an inside containing a peripheral device 4 and a power supply 5, and the rear plate 22 of the second shell 2 has an opening 220 for mounting a fan unit 51 of the power supply 5. Thus, the opening 220 of the second shell 2 is aligning with the air outlet 120 of the first shell 1 when the second shell 2 is disposed at the first position as shown in FIG. 1, so that the heat produced by the power supply 5 is carried by the fan unit 51 of the power supply 5 and is drained from the opening 220 of the second shell 2 and the air outlet 120 of the first shell 1.

It is appreciated that, the second shell 2 is rotatable to the second position as shown in FIG. 3 by action of the gravity and the pivot mechanism, so that the second shell 2 is rested on a table (not shown) and will not be returned to the first position as shown in FIG. 1, thereby preventing the second shell 2 from pressing the user's arm.

Accordingly, the pivot shafts 32 are inserted into the bushings 30 simultaneously in the same direction to connect the first shell 1 and the second shell 2, so that the second shell 2 is connected to the first shell 1 easily and quickly. In addition, the second shell 2 is a component of the computer housing, so that it is unnecessary to manufacture a rotation case additionally, thereby decreasing the costs of fabrication. Further, when the second shell 2 is disposed at the second position where the second shell 2 is spaced from the first shell 1, the mounting space 2A is defined between the first shell 1 and the second shell 2 to facilitate maintenance or assembly of the main board or other parts by the user.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A computer housing, comprising:
a first shell having a first side plate having an end formed with an opening and a second side plate located opposite to the first side plate;
a pivot mechanism;
a second shell connected to the first shell by the pivot mechanism, so that the second shell is rotatable between a first position and a second position;
the second shell having a front plate and a rear plate;
wherein, when the second shell is disposed at the second position, a mounting space is defined between the first shell and the second shell, and when the second shell is disposed at the first position, the mounting space is occupied by the second shell, while the front plate of the second shell is flush with the opening of the first shell;
wherein, the pivot mechanism includes two co-axial bushings mounted on two ends of a side of the first shell respectively, and two pivot shafts mounted on two ends of a side of the second shell respectively and each pivotally mounted in the respective bushing.

2. The computer housing in accordance with claim 1, wherein the two pivot shafts are directed toward the same direction, so that the pivot shafts are inserted into the bushings in the same direction.

3. The computer housing in accordance with claim 1, wherein each of the pivot shafts has a fixed end and a free end, and the free ends of the pivot shafts are directed toward the same direction, so that the pivot shafts are inserted into the bushings simultaneously in the same direction to connect the first shell and the second shell.

4. The computer housing in accordance with claim 1, wherein one of the pivot shafts has an inside formed with a screw bore, and the computer housing further comprises a screw screwed into the screw bore of the respective pivot shaft and rested on the respective bushing to lock the respective pivot shaft onto the respective bushing.

5. The computer housing in accordance with claim 1, wherein the second side plate of the first shell has an air outlet, and the rear plate of the second shell has an opening aligning with the air outlet of the first shell when the second shell is disposed at the first position.
